(19) United States
(12) Patent Application Publication
(10) Pub. No.: US 2014/0353949 A1
(43) Pub. Date: Dec. 4, 2014

(54) CURTAIN AIRBAG AND CURTAIN AIRBAG DEVICE

(71) Applicant: Takata Corporation, Tokyo (JP)

(72) Inventor: Sakae SUGIMORI, Tokyo (JP)

(73) Assignee: Takata Corporation, Tokyo (JP)

(21) Appl. No.: 14/294,844

(22) Filed: Jun. 3, 2014

(30) Foreign Application Priority Data
Jun. 4, 2013 (JP) 2013-117837

(51) Int. Cl. B60R 21/2338; B60R 21/232

(52) U.S. Cl. CPC B60R 21/2338; B60R 21/232; B60R 2021/23386
USPC 280/728.2

(57) ABSTRACT

The disclosure discloses a curtain airbag comprising a roll body that is constructed by winding an airbag main body toward an upper edge portion side of a vehicle body, and a tether that is integrally embedded in the airbag main body or is attached to the airbag main body, has a base end connected to at least one end of both ends of the airbag main body in a vehicle body front-back direction, and is provided, at a tip end, with a vehicle body attaching portion for attaching to the vehicle body, the roll body having a derived portion that is formed in the at least one end connected to the tether and that derives the airbag main body on the one end side while pulling in the airbag main body on an side opposite to the one end side, in the winding into a roll shape.

### BACKGROUND OF THE INVENTION

1. Field of the Invention

The present invention relates to a curtain airbag which restrains an occupant at a side surface of a vehicle body, and a curtain airbag device which has the curtain airbag.

2. Description of the related Art

As one type of airbag mounted to a vehicle body, there is a curtain airbag which inflates and develops downward at a side portion of a vehicle body, and restrains the occupant from the side (refer, for example, to patent document 1 (JP, B, 5029578)).

The curtain airbag according to the prior art is stored in a storage which is positioned in a pillar of the vehicle body or an upper portion of a window. When gas is supplied from an inflator, the curtain airbag comes out in a passenger room of the vehicle from the storage, and inflates and develops along the pillar or the window. At this time, by setting a tether from each end of the curtain airbag in a vehicle front-back direction, a predetermined tension (tensile force) in a front-back direction is applied to the curtain airbag upon inflation and development.

In the prior art, the curtain airbag is stored while being curved like an arcuate shape along an intersecting corner between a ceiling portion and a side surface portion in the room of the vehicle body, in a state of being rolled up. Therefore, the curved shape is removed and the curtain airbag is approximately linear in the case that the curtain airbag comes out from the intersecting corner portion. Then, the curtain airbag hangs down in a state in which a total length along a length direction becomes shorter than in the state being curved and stored. As a result, the application of the tension is insufficient upon the inflation and development, even if the tension is sufficiently applied by the tether in the curved and stored state (that is, the tension application state is uneven between before and after the inflation and development). As a result, in the prior art, the uniform tension application is achieved on both states between before and after the inflation and development, by provision of an auxiliary tether which further lifts up the tether.

### Problem to be Solved by the Invention

As mentioned above, in the prior art, in order to uniformly apply the tension before and after the inflation and development, it is necessary to install the auxiliary tether in addition to the normal tether in the front-back direction. As a result, a complication in structure and a cost increase are caused.

### SUMMARY OF THE INVENTION

An object of the present invention is to provide a curtain airbag which can achieve uniform tension application before and after inflation and development without causing complicated structure, and a curtain airbag device using the curtain airbag.

In order to achieve the above-described object, according to the first invention, there is provided a curtain airbag comprising a roll body that is constructed by winding into a roll shape an airbag main body having an approximately rectangular shape toward an upper edge portion side of a vehicle body, and an approximately band-like tether that is integrally embedded in the airbag main body or is attached to the airbag main body, has a base end connected to at least one end of both ends of the airbag main body in a vehicle body front-back direction, and is provided, at a tip end, with a vehicle body attaching portion for attaching to the vehicle body, the roll body having a derived portion that is formed in the at least one end connected to the tether and that derives the airbag main body on the at least one end side while pulling in the airbag main body on an side opposite to the one end side along the vehicle body front-back direction, in the winding into the roll shape.

In a first invention, the base end of the tether is connected to at least one end of both ends in a vehicle body front-back direction in the approximately rectangular airbag main body. The tether is integrally embedded in the airbag main body or is attached to the airbag main body. Further, the airbag main body connected to the tether as mentioned above is rolled up toward the upper edge portion side of the vehicle body, and forms the roll body. When the airbag main body is rolled up, the end of the air bag main body to which the tether is connected is derived in the vehicle body front-back direction (by pulling in and winding the airbag main body of the other end) to form the derived portion. After the roll body is wound, there is established a state in which the tether to be attached to the vehicle body is connected with respect to the derived portion which protrudes out of the roll body in the above manner.

The roll body is stored like the arcuate shape while elongating the total length by protruding the derived portion out of the end as mentioned above. The roll body inflates and develops while pulling in the derived portion to the opposite of the protruding direction upon the coming inflation and development. Thereby, it is possible to make approximately identical a distance which is required for connecting the end of the airbag main body with the vehicle body side when linearly inflating and developing (that is, a length required for tether to make connection, and a distance which is required for connecting the end of the airbag main body with the vehicle body side in the arcuate-shaped curved and stored state (that is, a length required for tether connection in the same manner as mentioned above). Thus, only by the provision of the normal tether of approximately band shape (instead of providing the auxiliary tether like the conventional structure), the state of approximately uniform tension application can be achieved by the tether in both before and after the inflation and development.

According to the second invention, in the curtain air bag according to the first invention, the tether includes a breaking portion configured to restrain a part of the tether in a short and small state in which the tether is partly folded at normal time, and to achieve a long and large state of the tether by breaking upon inflation and development of the airbag main body so as to remove the restraint.

In a second invention of the present application, the breaking portion is provided in the tether. Further, on the basis of the function of the breaking portion, the tether is restrained in the short and small state in which the tether is partly folded at normal time. The restraint is removed (by the breakage of the breaking portion) when the airbag main body inflates and develops. As a result, the long and large state of the tether is realized. Therefore, the tether can be made relatively short, for example, during inflating and developing of the airbag main body (without breakage of the breaking portion). Further, the length of the tether can be elongated (by the breakage of the breaking portion) after the inflation and development. It is possible to make the tension applied to the airbag main body along the vehicle front-back direction relatively larger (while schematically making the magnitude of the tension approximately equal between before and after the inflation and development as mentioned above) by making the tether relatively short upon the inflation and development. As a result, it is possible to make a dimension in a thickness direction of the airbag main body during the developing smaller (thinner than the normal size). Therefore, it is possible to make the airbag main body enter a comparatively narrow space between an occupant and a vehicle door or a window while developing the airbag main body. In other words, it is possible to make the airbag main body inflate and develop at a position apart from the occupant so that the airbag main body rarely interferes with the occupant. Particularly, the restraint in the above manner is also effective for an occupant who is not seated at the normal position.

On the other hand, a relatively longer tether after the inflation and development of the airbag main body enables to cause the tension applied to the airbag main body relatively small, and the dimension of the airbag main body in the thickness direction larger (back to the normal size). As a result, it is possible to appropriately restrain the occupant with the larger dimension in the thickness direction, after the inflation and development.

According to the third invention, in the curtain air bag according to the first invention, the tether is structured such that a total length in the short and small state is set to be shorter than a total length in the long and large state, by an amount corresponding to a deriving length of the derived portion.

As such, it is possible to approximately bring one tension-applied state into line with the other tension-applied state when inflating and developing while hanging down in the approximately linear state. The one tension-applied state is formed by the tether before starting deriving the derived portion and just after the hanging down without the breakage of the breaking portion. The other tension applied state is formed by the tether when the derived portion is derived and the inflation and development is completed with the breakage of the breaking portion. As a result, it is possible to securely make the tension smaller by setting the deriving length of the derived portion long, and make the tension larger by setting the deriving length of the derived portion short. In other words, it is possible to adjust the tension with a high precision according to the deriving length of the derived portion.

According to the fourth invention, there is provided a curtain airbag device comprising the curtain airbag according to the first invention, and an inflator configured to supply gas for inflating and developing the curtain airbag.

### Effect of the Invention

According to the present invention, it is possible to achieve the uniform tension application before and after the inflation and development without causing any complication in structure.

### BRIEF DESCRIPTION OF THE DRAWING

FIG. 1 is a side elevational view of a curtain airbag according to an embodiment of the present invention.

FIG. 2 is a side elevational view of a curtain airbag in an example in which arrangement of a tether is changed from forward to rearward.

FIG. 3A is a view showing a roll body to which an airbag main body is wound.

FIG. 3B is a view showing the roll body in a state in which a derived portion is formed after winding.

FIG. 4A is a perspective view showing a structure of a substantial part before a tip end side of the roll body is derived.

FIG. 4B is a perspective view of the structure of the substantial part after the tip end side of the roll body is derived.

FIG. 4C is a vertical cross sectional view along a cross section IV-IV in FIG. 4B.

FIG. 5 is an outer appearance view showing a state in which an airbag main body 1 is attached to a vehicle body.

FIG. 6 is a side elevational view as seen from an inner portion of a vehicle body and shows a state in which a curtain airbag device is installed to the vehicle body.

FIG. 7 is a side elevational view of a curtain airbag according to a modified example in which a breaking portion is constructed by a slit tether.

FIG. 8 is a side elevational view of a curtain airbag according to a modified example in which arrangement of the slit tether is reversed from rearward to forward.

FIG. 9A is a perspective view showing a structure of a substantial part in the vicinity of the tether and a derived portion.

FIG. 9B is a vertical cross sectional view along a cross section IX-IX in FIG. 9A.

FIG. 10 is a side elevational view of a curtain airbag before the tether is extended in a modified example in which a folded portion is directly seamed.

FIG. 11 is a side elevational view of the curtain airbag in a state in which the tether is extended.

FIG. 12A is a perspective view showing a structure of a substantial part in the vicinity of the tether and a derived portion.

FIG. 12B is a vertical cross sectional view along a cross section XII-XII in FIG. 12A.

FIG. 13 is a side elevational view of a curtain airbag in a modified example in which breaking portions are provided in both ends.

### DETAILED DESCRIPTION OF THE PREFERRED EMBODIMENTS

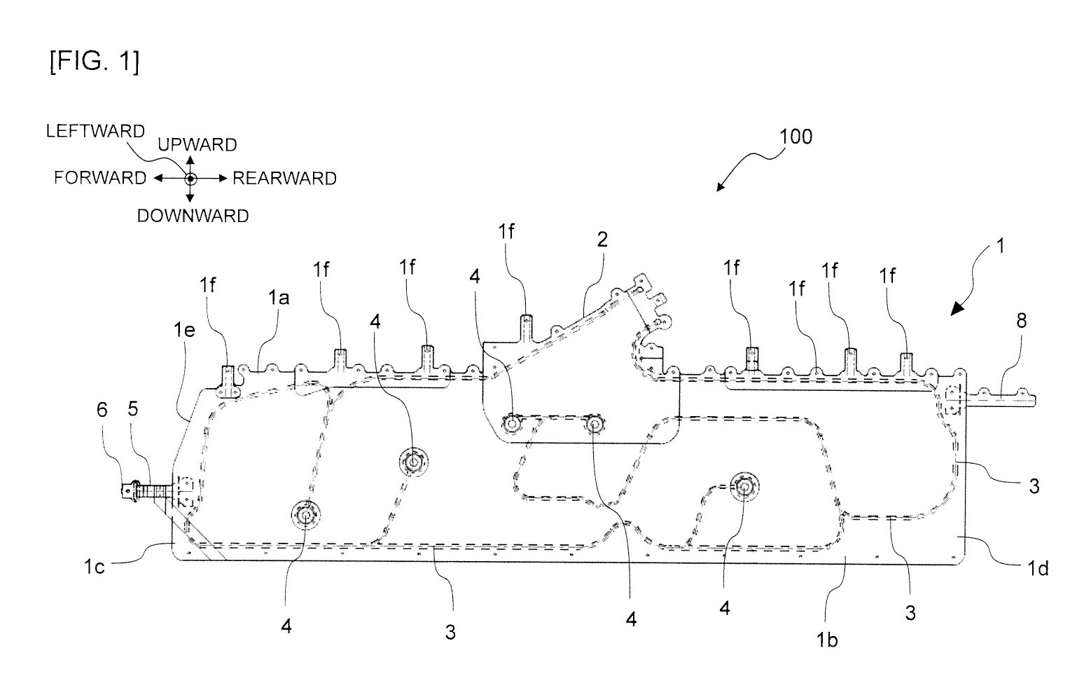

A description will be given below of a first embodiment according to the present invention with reference to the accompanying drawings. In the following description, an upward and downward direction, a forward and rearward direction, and a rightward and leftward direction of a vehicle body correspond to directions of arrows which are appropriately shown in each of the drawings such as in FIG. 1.

### Embodiments

A description will be given below of a curtain airbag device having a curtain airbag according to an embodiment of the present invention with reference to FIGS. 1 to 6.

FIG. 1 is a side elevational view showing in a perspective manner an internal structure of the curtain airbag according to the present embodiment in a state of being developed.

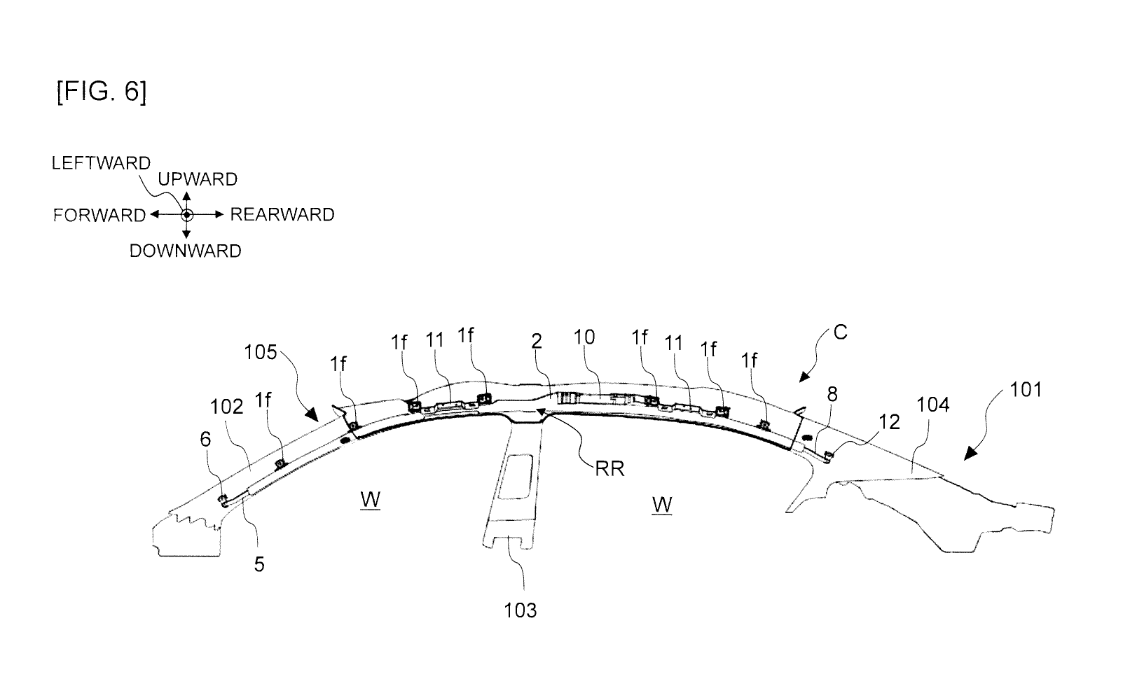

In FIG. 1, a curtain airbag 100 according to the present embodiment has an airbag main body 1. The airbag main body 1 has a length at which the airbag main body 1 can inflate in a wide range from the forward of a vehicle body 101 (refer to FIG. 6 mentioned later) to the rearward, and a height at which the airbag main body 1 can inflate in a range from a ceiling side of the vehicle body 101 to a head portion and shoulders of an occupant. The airbag main body 1 is formed approximately into a rectangular shape. The rectangular shape has an upper edge 1a and a lower edge 1b of a long side in a direction extending along the forward and rearward direction of the vehicle body 101, and a front end 1c and a rear end 1d of a short side in a direction extending along the upward and downward direction of the vehicle body 101. In the airbag main body 1, an inclined portion 1e is formed in the front end 1e which is the forward of the vehicle body. The inclined portion 1e is inclined low in the front and high in the rear according to a vehicle body shape. The inclined portion 1e may not be necessarily provided in consideration of a relationship with the vehicle body shape (for example, a shape or an angle of a front pillar, or a size of the airbag main body 1).

In the airbag main body 1, an introduction part 2 for pressure gas is integrally formed in the vicinity of the center of the upper edge 1b. Further, the airbag main body 1 has a seamed portion 3 and a discharge port 4. The seamed portion 3 swells and inflates to a thickness restraining the occupant front and rear of the vehicle body by specifying an introducing direction of pressure gas introduced from the introduction part 2 and an inflating order. The discharge port 4 discharges the pressure gas after inflating. In this example, the gas introduction part 2 of the pressure gas is provided in the vicinity of the center of the airbag main body 1. However, the gas introduction part 2 may be provided in an end portion on a rear side of the airbag main body 1 without being limited to the type mentioned above.

A plurality of attaching ribs 1f is integrally formed in the upper edge 1a of the airbag main body 1 for attaching along the forward and rearward direction of the vehicle body 101. A base end of an approximately band-shaped tether 5 is attached by seaming to the vicinity of the center in a height direction of the front end 1c of the airbag main body 1. A vehicle body attaching member 6 is provided in a tip end of the tether 5. Further, a base end of an approximately band-shaped tether 8 is attached by seaming to the vicinity of an upper portion in a height direction of the rear end 1d of the airbag main body 1.

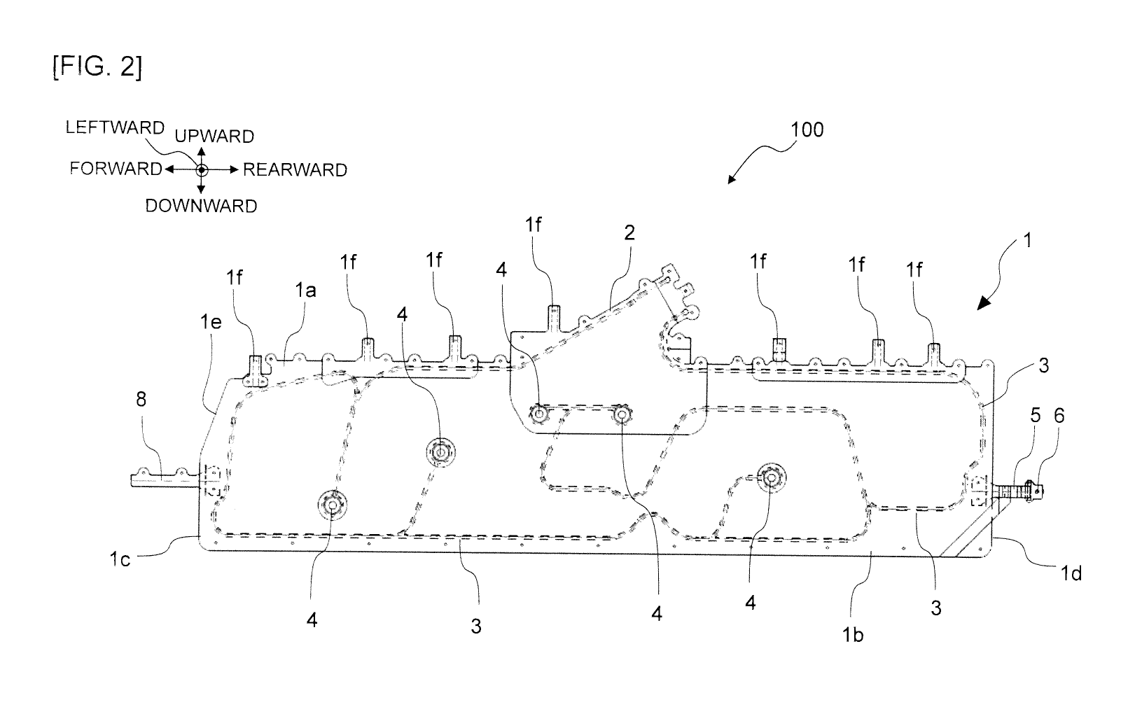

In the airbag main body 1, the tether 5 and the tether 8 may be provided inversely forward and rearward in a positional relationship with the vehicle body 101, as shown in FIG. 2. In this case, the base end of the tether 5 is attached to the vicinity of the center in the height direction of the rear end 1d of the airbag main body 1, and the vehicle body attaching member 6 is provided in the tip end thereof. Further, the base end of the tether 8 is provided in the vicinity of the center in the height direction of the front end 1c of the airbag main body 1. Further, the tether 5 and the tether 8 may be attached by seaming to the airbag main body 1, or may be integrally embedded in the airbag main body 1.

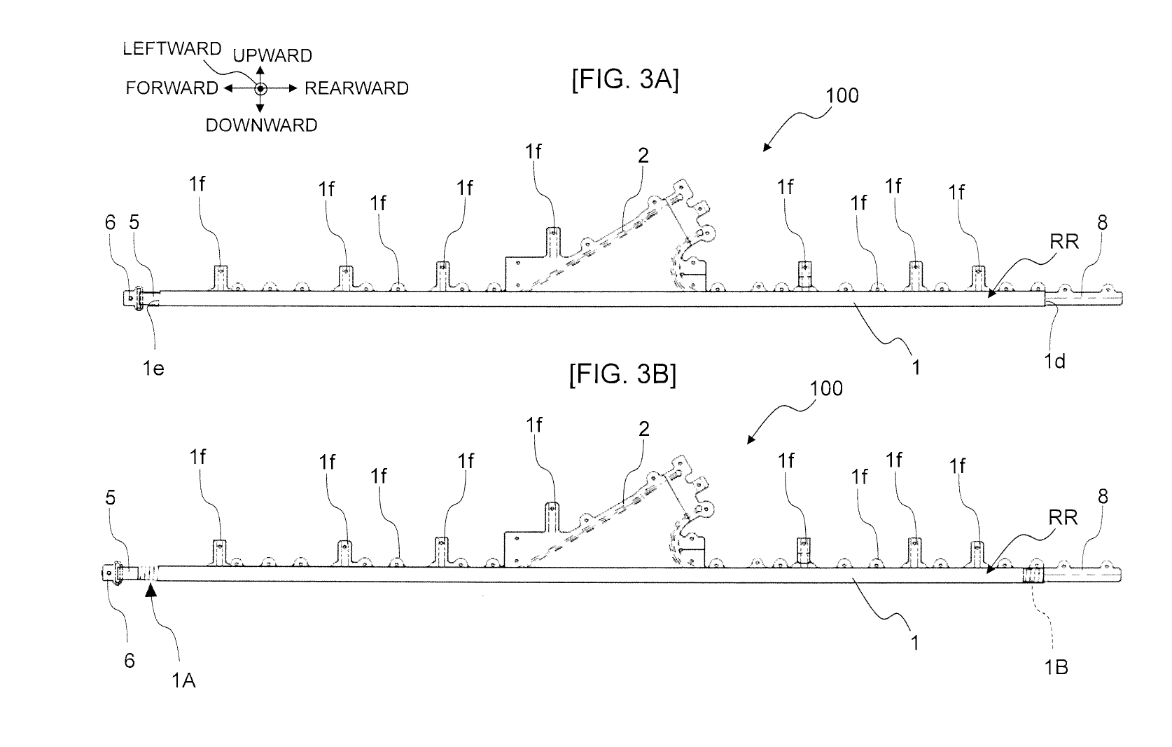

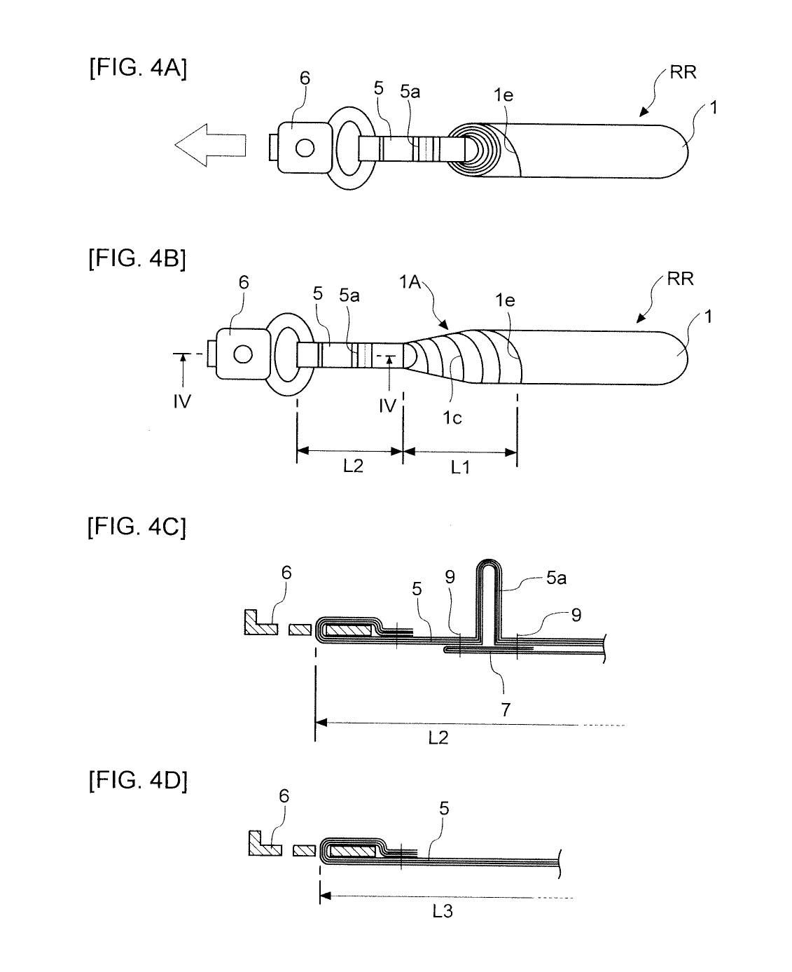

In the present embodiment, a roll body RR is formed, as shown in FIG. 3A and FIG. 4A, by rolling up sequentially from the lower edge 1b toward the upper edge 1a while using the airbag main body 1 mentioned above. Thereafter, in the roll body RR, the front end 1c side of the airbag main body 1 is derived while pulling in the rear end 1d side thereof. As a result, as shown in FIGS. 313 and 4B, a derived portion 1A is formed in such a manner that a forward side edge portion is continuously formed into a spiral shape. At the same time, a pulling-in portion 1B caused by pulling in is simultaneously formed on the rear end 1d side of the airbag main body 1. As a result, the roll body RR comes to a state in which a total length is elongated in the vehicle body front-back direction in the vehicle body installing state (in comparison with before the installation) in spite of unchanged length of the airbag main body 1. The derived portion 1A may be derived after being rolled up, or may be derived at the same time of being rolled up.

On the other hand, in the tether 5, a folded portion 5a is formed in an intermediate portion in a longitudinal direction, as shown in FIG. 4C. Both end portions in the length direction of the folded portion 5a are connected to a common connection portion 7 via seams 9. As a result, the folded portion 5a restrains in a short and small state in which a part (the folded portion 5a) of the tether 5 is folded at the normal time shown in FIG. 4C. Further, upon the inflating and developing of the airbag main body 1 shown in FIG. 4D, the restraint is removed by breaking the seams 9 and a long and large state of the tether 5 is achieved. Therefore, the connection portion 7 and the seams 9 serve as a breaking portion described in each of claims (details thereof will be mentioned later).

A length L3 is a length of the tether 5 in a state in which the seams 9 are broken and the folded portion 5a disappear (the long and large state), as shown in FIG. 4D. A length L2 is a length of the tether 5 in a state in which the folded portion 5a is formed (the short and small state), as shown in FIG. 4C. At this time, a difference of L3−L2 is approximately the same as a length L1 of the derived portion 1A from the inclined portion 1e which is positioned on the upper edge 1a side of the front end 1c of the airbag main body 1, to the connection portion of the tether 5.

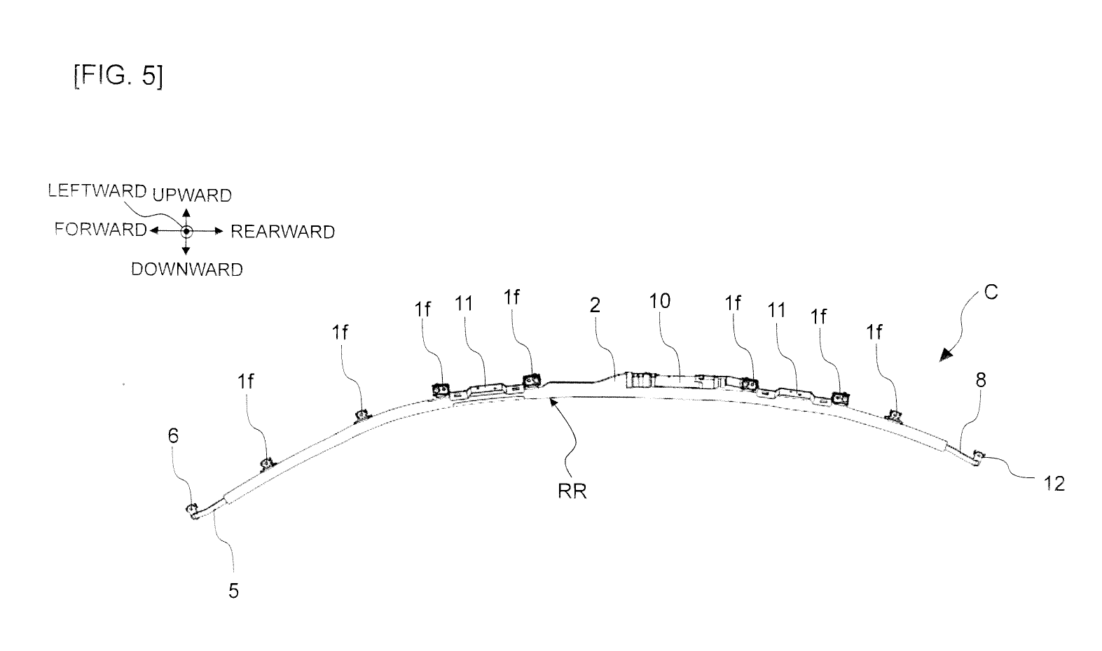

FIG. 5 is an outer appearance view showing a state in which the airbag main body 1 is attached to the vehicle body 101. FIG. 6 is a side elevational view as seen from an inner portion of the vehicle body, and shows a state in which the curtain airbag device is installed to the vehicle body 101.

As shown in FIGS. 5 and 6, the airbag main body 1 is formed into an arcuate curved shape in conformity to a state in which the airbag main body 1 is attached to and stored in the vehicle body 101 (refer to FIG. 6). An inflator 10 is attached to the introduction part 2. Further, brackets 11 are appropriately attached to the upper edge 1a according to a shape and a structure of the vehicle body. A curtain airbag device C is constructed by the curtain airbag 100 (which is shown as the roll body RR in the drawing) having the airbag main body 1 and the tethers 5 and 6, and the inflator 10.

The curtain airbag device C is arranged like an arcuate shape in a roof side rail 105 from a front pillar 102 of the vehicle body 101 of the vehicle to a rear pillar 104 via a center pillar 103. The curtain airbag device C is fixed to the vehicle body 101 by fastening attachments which are installed to the attaching ribs 1f and are not shown, the vehicle body attaching member 6 which is provided in the tether 5, and the vehicle body attaching member 12 which is provided in the tether 8, while using bolts, rivets and the like.

The inflator 10 is controlled by an inflator control circuit (not shown). The inflator control circuit detects collision and transmits an ignition signal to the inflator 10. In the case that the inflator 10 is activated by the inflator control circuit, the pressure gas is inserted to the airbag main body 1. In the airbag main body 10, the state in which the airbag main body 10 is wound as the roll body RR is removed by the introduction of the pressure gas, and the lower edge 1b inflates and develops toward the downward of the vehicle body. As a result, the airbag main body hangs down toward the downward of the vehicle body in such a manner as to enter into a comparatively narrow space between the occupant and a window W (refer to FIG. 6), and swells so as to restrain the occupant.

In the present embodiment structured as mentioned above, the following operations and effects are achieved.

More specifically, in the curtain airbag 100 according to the present embodiment, the base end of the tether 5 is connected to the front end 1c (the rear end 1d in the example in FIG. 2, the same shall apply hereafter) of the approximately rectangular airbag main body 1. Further, the airbag main body 1 to which the tether 5 is connected is rolled up toward the upper edge la side of the vehicle body 101 to form the roll body RR. At this time, in the case that the airbag main body 1 is rolled up, the end portion of the airbag main body on the front end 1c side to which the tether 5 is connected is derived to the forward side of the vehicle body (by winding the airbag main body 1 on the rear end 1d side which is an opposite side thereto while pulling in the airbag main body 1) to form the derived portion 1A. After the roll body RR is wound, there comes the state in which the tether 5 for attaching the vehicle body is connected to the derived portion 1A which protrudes out of the roll body RR as mentioned above.

The roll body RR is stored like the arcuate shape while elongating the total length by protruding the derived portion 1A out of the front end 1c side as shown in FIGS. 3, 5 and 6. Further, the roll body RR inflates and develops while pulling in the derived portion 1A to the opposite (that is, rearward) of the protruding direction, upon the coming inflation and development. As a result, it is possible to make a distance which is required for connecting the front end 1c of the airbag main body 1A with the vehicle body 101 side (in other words, a length which is necessary for connecting the tether 5) in the case of inflating and developing linearly, approximately the same as a distance which is required for connecting the front end 1c of the airbag main body 1 with the vehicle body side (a length which is required for connecting the tether 5 in the same manner as mentioned above) in a state of the curved stored state like the arcuate shape. Therefore, it is possible to achieve approximately the same tension application state by the tether 5, in both before and after the inflation and development, only by setting the normal approximately band-like tether 5 (without provision of any auxiliary tether in the conventional structure).

Further, in the present embodiment, the tether 5 particularly has the folded portion 5a. The folded portion 5a is connected to the connection portion 7 by the seams 9. Further, the folded portion 5a is restrained in the short and small state in which the folded portion 5a is folded during the inflation and development (refer to FIGS. 413 and 4C). On the other hand, when the airbag main body 1 inflates and develops, the seams 9 are broken so as to remove the restraint. As a result, there comes the long and large state in which the length of the tether 5 is the longest (refer to FIG. 4D). It is possible to make the tension acting on the airbag main body 1 along the vehicle front-back direction relatively large (while schematically making the magnitude of the tension approximately the same between before and after the inflation and development as mentioned above), by making the tether 5 relatively short upon the inflation and development. Therefore, it is possible to make the dimension in the thickness direction of the airbag main body 1 during the developing small (thinner than the normal size). As a result, it is possible to make the airbag main body 1 enter the comparatively narrow space between the occupant and the vehicle door or the window W while developing the airbag main body 1. In other words, it is possible to make the airbag main body 1 inflate and develop at a position apart from the occupant so that the airbag main body 1 rarely interferes with the occupant. Particularly, it is possible to restrain the occupant who is not seated at the normal position by the entering of the airbag main body 1.

On the other hand, it is possible to make the tension applied to the airbag main body 1 relatively small, and it is possible to make the dimension in the thickness direction of the airbag main body 1 larger (back to the normal size), by making the tether 5 relatively longer after the inflation and development of the airbag main body 1. As a result, it is possible to appropriately restrain the occupant with the large dimension in the thickness direction, after the inflation and development.

Further, in the present embodiment, the tether 5 is particularly set so that the total length L2 in the short and small state is shorter than the total length (the length L3) in the long and large state, by the amount corresponding to the deriving length (the length L1) of the derived portion 1A. Specifically, the tether 5 is set so as to satisfy L3−L2=L1. As a result, it is possible to approximately bring one tension-applied state into line with the other tension-applied state when the airbag main body 1 inflates and develops while hanging down in the approximately linear state. The one tension-applied state is formed by the tether 5 before starting deriving the derived portion 1A and just after hanging down without the breakage of the folded portion 5a. The other tension-applied state is formed by the tether 5 when the derived portion 1A is derived and the inflation and development is finished with the breakage of the folded portion 5a. As a result, it is possible to securely make the tension small by setting the deriving length of the derived portion 1A longer, and it is possible to securely make the tension large by setting the deriving length of the derived portion 1A shorter. In other words, it is possible to adjust the tension with a high precision according to the deriving length of the derived portion 1A.

### Modified Example Constructing Breaking Portion by Using Slit Tether

In the embodiment mentioned above, the elongated state of the tether 5 (the so-called cut tether) is achieved by connecting the folded portion 5a by the seams 9 and breaking the seams 9 upon the inflation and development, however, the breaking structure is not limited to the structure mentioned above.

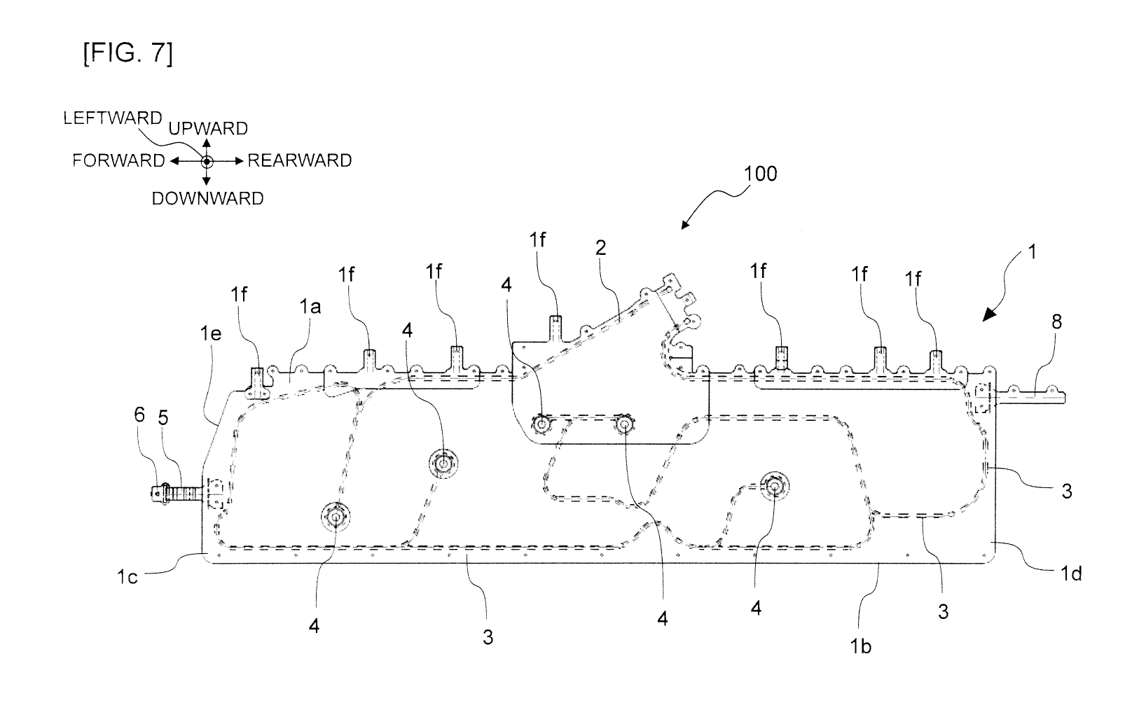

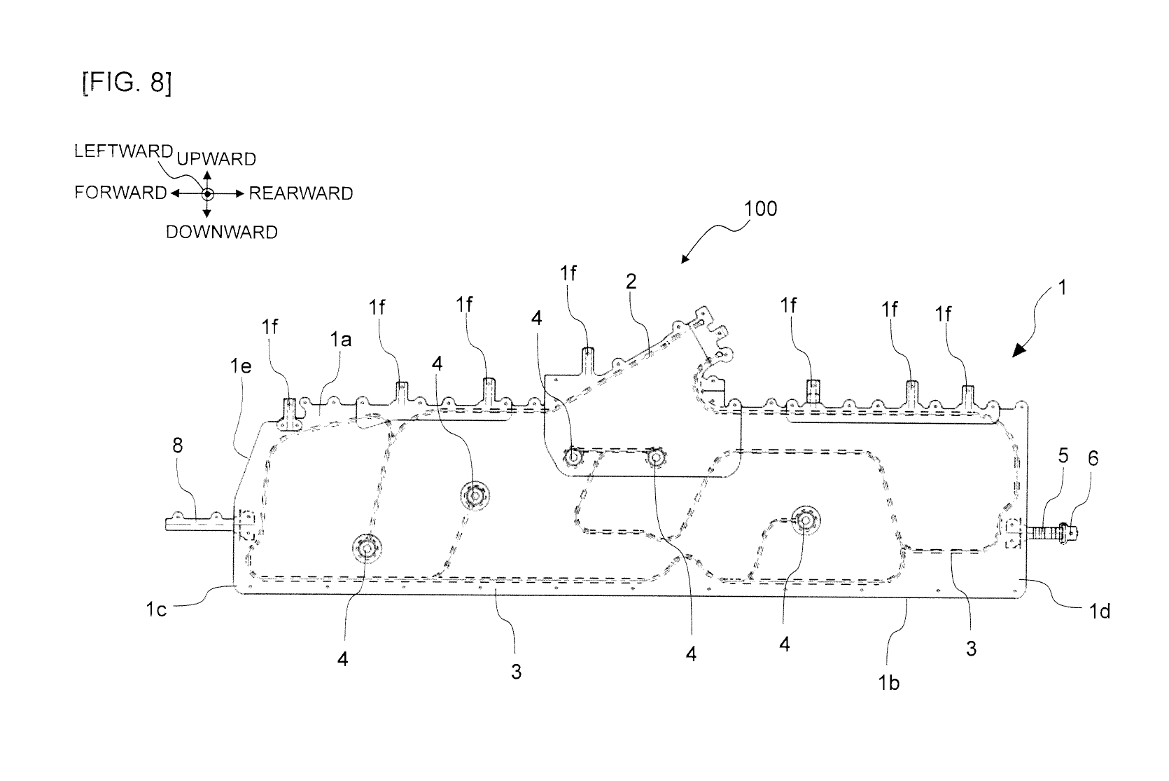

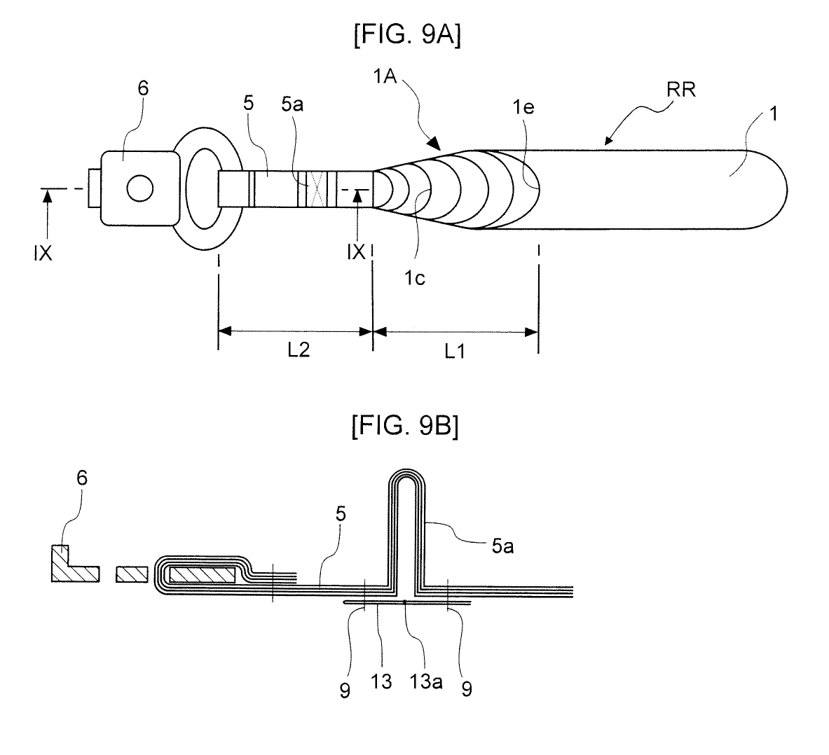

FIGS. 7 to 9 show a modified example structured such as to maintain the folded state of the folded portion 5a by the seams 9 while using a slit tether 13 in which a slit 13a is previously formed as a breaking scheduled portion. FIG. 7 corresponds to FIG. 2 in the embodiment mentioned above. FIG. 8 corresponds to FIG. 3 in the embodiment mentioned above, and FIG. 9 corresponds to FIG. 4 in the embodiment mentioned above. In FIGS. 7 to 9, the same reference numerals are attached to the same structures as those of the embodiment mentioned above and a description thereof will be omitted. In the present modified example of the structure shown in FIGS. 7 to 9, the folded state of the folded portion 5a is removed, in the same manner as the embodiment mentioned above, by breaking the slit 13a on the basis of the pressure when the airbag main body 1 inflates and develops. Therefore, the tether 5 can be extended and the same effect can be obtained. In the present modified example, the slit 13a serves as the breaking portion described in each of claims.

### Modified Example Constructing Breaking Portion by Directly Seaming Folded Portion

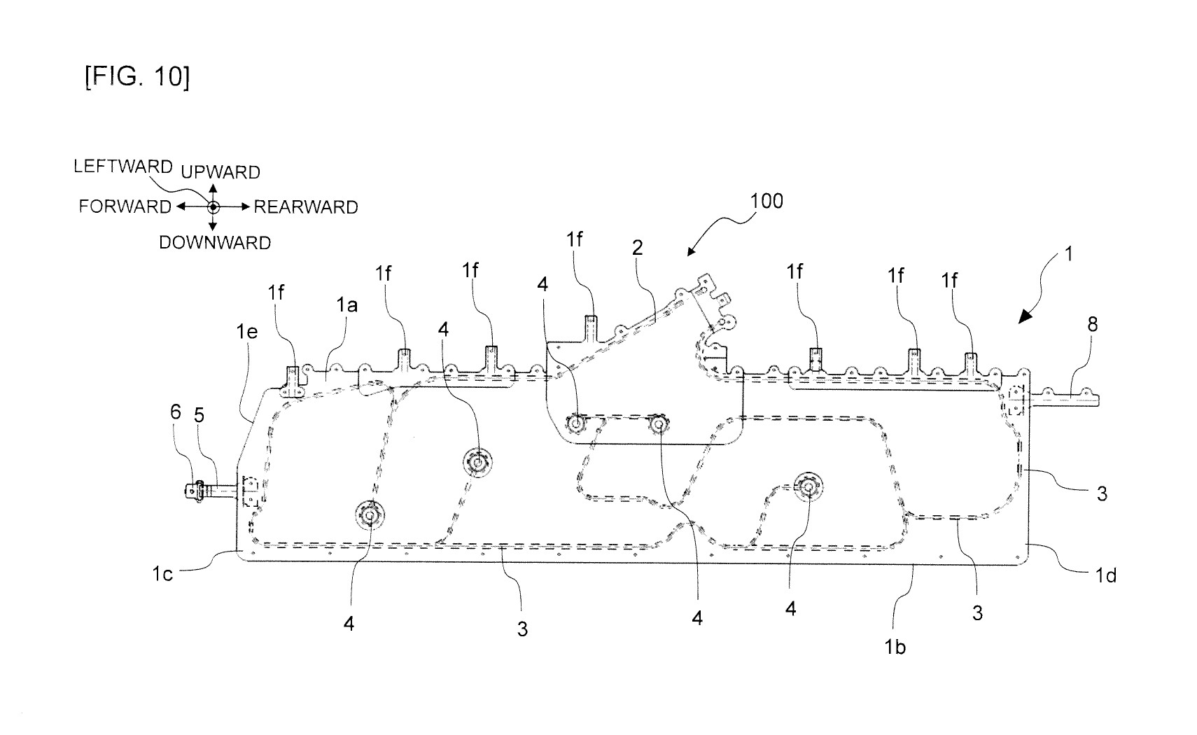

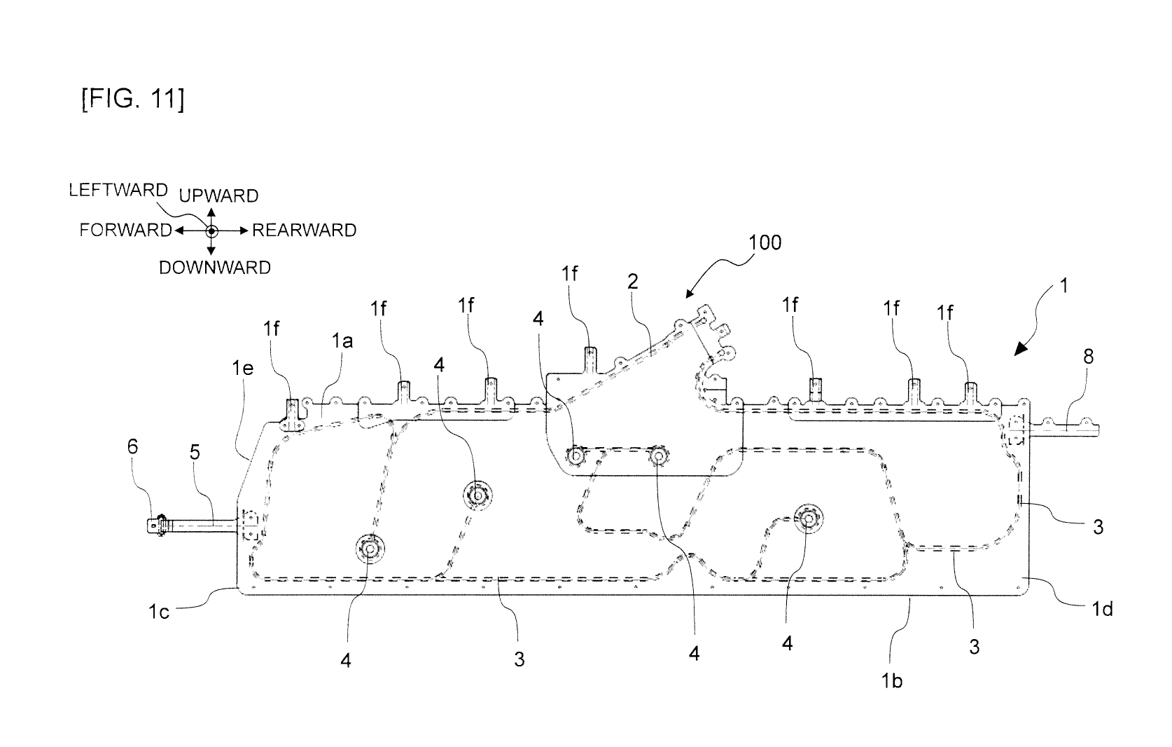

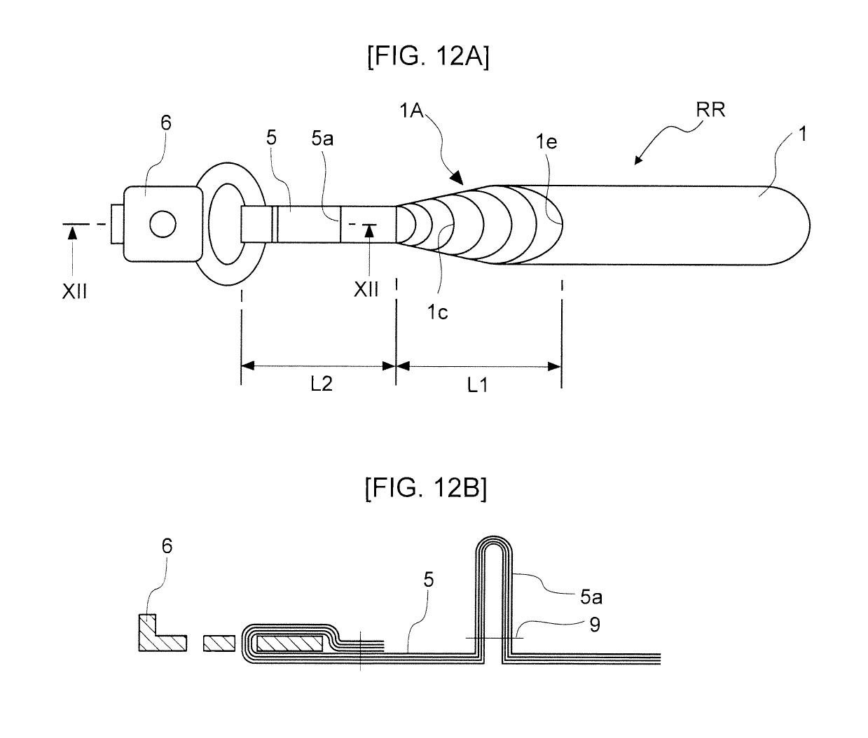

FIGS. 10 to 12 show a modified example structured such as to maintain a folded state by connecting a folded portion 5a by a seam 9. FIG. 10 corresponds to FIG. 2 in the embodiment mentioned above, and FIG. 11 shows an elongated state of a tether in which the seam 9 is broken from the state in FIG. 10. Further, FIG. 12 corresponds to FIG. 4 in the embodiment mentioned above. In FIGS. 10 to 12, the same reference numerals are attached to the same structures as those of the embodiment mentioned above, and a description thereof will be omitted. Even in the present modified example of the structure shown in FIGS. 10 to 12, the folded state of the folded portion 5a is removed as shown in FIG. 11, in the same manner as the embodiment mentioned above, by breaking the seam 9 on the basis of the pressure when the airbag main body 1 inflates and develops. Therefore, the tether 5 can be extended and the same effect can be obtained. In the present modified example, the seam 9 serves as the breaking portion described in each of claims.

### Modified Example in Which Tethers with Folded Portions are Provided on Both Ends

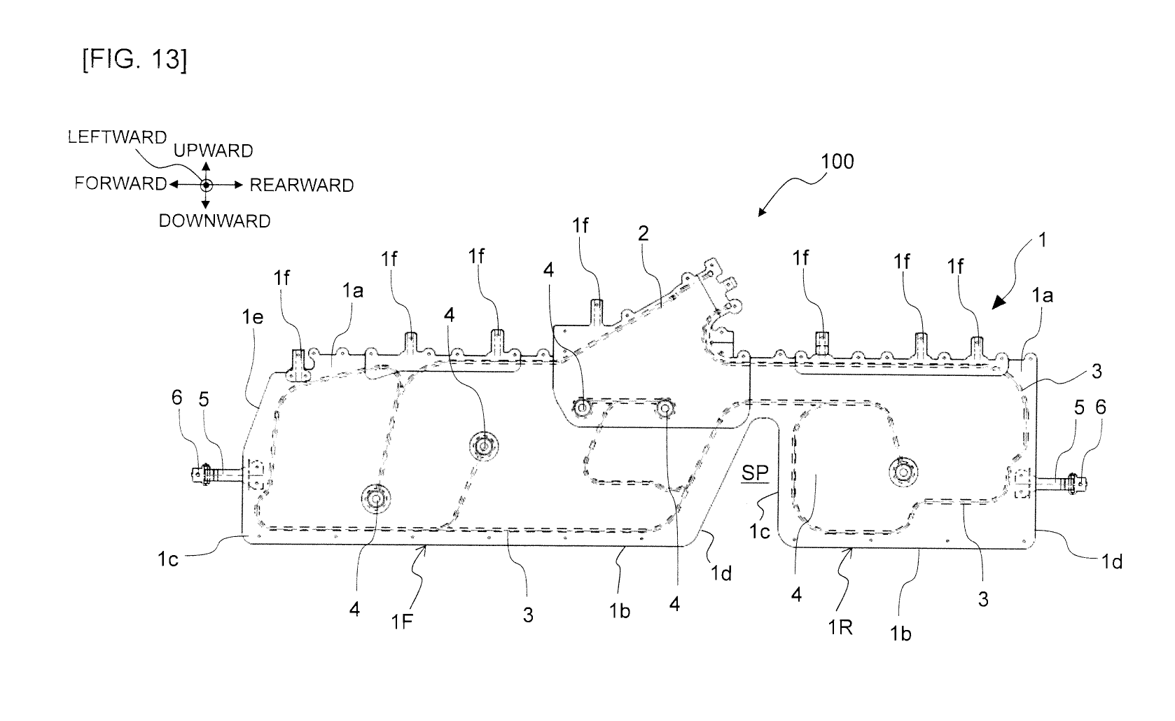

Further, as shown in FIG. 13, the tether 5 may be provided in both ends 1c and 1d of the airbag main body 1. In this case, the airbag main body 1 is separated into two parts via a space portion SP. The space portion SP is provided in such a manner as to cut into from downward. The parts of the airbag main body 1 include a forward side main body portion 1F and a rearward side main body portion 1R. Further, when the roll body RR is formed as mentioned above, both the forward side main body portion 1F and the rearward side main body portion 1R are sequentially rolled up from a lower edge 1b toward an upward edge 1a approximately at the same time. In other words, since the forward side main body portion 1F is wound, a forward side portion (not shown) of the roll body RR is formed. Further, since the rearward side main body portion 1R is wound, a rearward side portion (not shown) of the roll body RR is formed.

In the case that the forward side portion of the roll body RR is formed, a front end 1c side is derived while pulling in a rear end 1d side of the forward side main body portion 1F in the same manner as the forming time of the one roll body RR. Therefore, a derived portion 1A (not shown) is formed in such a manner that the forward side edge portion is spirally continuous. Further, a pulling-in portion 1B (not shown) is simultaneously formed on the rear end 1d side of the forward side main body portion 1F according to the drawing. On the other hand, in the case that the rear side portion of the roll body RR is formed, the rear end 1d side is derived while pulling in the front end 1c side of the rearward side main body portion 1R. Therefore, the derived portion 1A (not shown) is formed in such a manner that the rear side edge portion is spirally continuous. Further, a pulling-in portion 1B (not shown) is simultaneously formed in the front end 1c of the rearward side main body portion 1R according to the drawing. The roll body RR having the forward side main body portion 1F and the rearward side main body portion 1R as mentioned above is formed. Therefore, the same effects as that of the embodiments mentioned above can be obtained.

Further, in addition to the examples which have been already mentioned, the techniques according to the embodiments mentioned above and each of the modified examples can be appropriately combined and utilized.

In addition, the present invention can be executed by applying various changes within the range which does not depart from the scope of the present invention, although they are not exemplified.

What is claimed is:

1. A curtain airbag comprising:
a roll body that is constructed by winding into a roll shape an airbag main body having an approximately rectangular shape toward an upper edge portion side of a vehicle body; and
an approximately band-like tether that is integrally embedded in said airbag main body or is attached to said airbag main body, has a base end connected to at least one end of both ends of said airbag main body in a vehicle body front-back direction, and is provided, at a tip end, with a vehicle body attaching portion for attaching to the vehicle body,
said roll body having a derived portion that is formed in said at least one end connected to said tether and that derives said airbag main body on the at least one end side while pulling in said airbag main body on an side opposite to the one end side along said vehicle body front-back direction, in said winding into the roll shape.

2. The curtain airbag according to claim 1, wherein:
said tether includes a breaking portion configured to restrain a part of the tether in a short and small state in which the tether is partly folded at normal time, and to achieve a long and large state of the tether by breaking upon inflation and development of said airbag main body so as to remove said restraint.

3. The curtain airbag according to claim 1, wherein:
said tether is structured such that a total length in said short and small state is set to be shorter than a total length in said long and large state, by an amount corresponding to a deriving length of said derived portion.

4. A curtain airbag device comprising:
the curtain airbag according to claim 1; and
an inflator configured to supply gas for inflating and developing said curtain airbag.
